(19) United States
(12) Patent Application Publication
(10) Pub. No.: US 2026/0339687 A1
(43) Pub. Date: Oct. 29, 2026

(54) RUNTIME OPTIMIZATION METHOD AND SYSTEM FOR PARALLEL COMPUTING APPLICATION BASED ON REMOTE INTELLIGENT SERVICE

(71) Applicant: University of Science and Technology of China, Hefei (CN)

(72) Inventors: Wenshuai Zhang, Hefei (CN); Jinyou Li, Hefei (CN); Yu Shen, Hefei (CN); Yundong Zhang, Hefei (CN); Huimin Li, Hefei (CN)

(21) Appl. No.: 19/641,597

(22) Filed: Apr. 8, 2026

(30) Foreign Application Priority Data
Apr. 9, 2025 (CN) 2025104370364

(51) Int. Cl. G06F 9/455

(52) U.S. Cl. CPC G06F 9/45516

(57) ABSTRACT

A runtime optimization method includes: acquiring and pushing application job features and local cluster features to a remote server; receiving, by the remote server, a processing request, performing, by a parameter search sub‑module, parameter prediction for the application job to obtain a list of parameter configuration values, and delivering the list to a local cluster; filtering out and feeding back, by the local cluster, a most suitable parameter configuration to the user, and modifying related settings of the application job followed by submitting to complete actual execution of the application job; monitoring, by the local cluster, the actual execution of the application job, and uploading an actual execution status result to the remote server; and expanding, by the remote server, a dataset in a historical job database, storing the actual execution status result into a dataset corresponding to an application category, and periodically updating the parameter search module.

### CROSS-REFERENCE TO RELATED APPLICATION

This application claims priority to Chinese Patent Application No. 202510437036.4, filed on Apr. 9, 2025, which is herein incorporated by reference in its entirety.

### TECHNICAL FIELD

The disclosure relates to the technical field of supercomputing clusters, and more particularly to a runtime optimization method and a runtime optimization system for a parallel computing application based on a remote intelligent service.

### BACKGROUND

With the rapid advancement of technology, the development of high-performance computing platforms has been progressing at an unprecedented pace, providing formidable momentum for complex computations and simulations. This progress enables researchers to efficiently process and analyze large-scale datasets in the field of scientific research within a reasonable timeframe, significantly enhancing the efficiency and stability of computational task execution. Numerous scientific software packages have been adapted for parallel configurations on high-performance platforms, such as the first-principles calculation software: Vienna Ab initio simulation package (VASP) widely used in materials science, and the classic molecular dynamics simulator: large-scale atomic/molecular massively parallel simulator (LAMMPS). Before such software runs in parallel on abundant computing resources, it is necessary not only to configure basic hardware resource parameters, such as the number of nodes allocated for running and the number of node cores, but also to address the high demands that structurally more complex software places on parallel parameter configurations strongly tied to domain-specific knowledge. For instance, regarding a job running on a cluster, a certain number of nodes and cores are allocated through job submission; the specific numbers and allocation are often determined based on factors such as past experience with running similar jobs and overhead costs of computing time. However, during the actual job running phase, the number of cores allocated per node directly impacts communication efficiency, computational speed, and storage security.

From the perspective of computer resource administrators, achieving maximum resource utilization is the core objective. In this context, configuring an optimized set of parallel parameters is crucial for enhancing job running efficiency. Therefore, conducting in-depth explorations into the parameter optimization of scientific research software holds important practical significance. However, currently deployed software on the cluster generally lacks detailed hardware configuration recommendations, which poses challenges for researchers, particularly for computational users without a computer science background. They often lack sufficient understanding of core allocation on the high-performance computing cluster, let alone the ability to master the complex parallel parameter configurations and optimization methods required by various software packages. This undoubtedly raises the barrier to entry for using research tools to a certain extent, hindering the efficient advancement of scientific work. For researchers, while ensuring job correctness and execution speed, learning how to save on job runtime costs and achieve effective resource utilization within a reasonable budget has become a key objective they pursue. This concerns not only the cost control of research projects but also the sustainable development of scientific endeavors.

Currently, there is a severe scarcity of high-quality job running datasets for specific tasks, which has become a major bottleneck restricting the development of this field. An existing Chinese patent with publication No.: CN114048027A, titled "a method for optimizing job runtime parameters applied to supercomputing cluster scheduling", provides an effective means for testing and evaluating the quality of various parameter configurations, and allows for the storage of test job running data to generate high-quality job data for a specific single cluster. However, analyzing data solely based on a single cluster and constructing a complete dataset from scratch locally are not only time-consuming and labor-intensive, but also inevitably leads to unnecessary data redundancy due to the repeated storage of running data for common scientific computing software on an overall basis, further exacerbating resource waste.

### SUMMARY

The purpose of the disclosure is to provide a runtime optimization method and a runtime optimization system for a parallel computing application based on a remote intelligent service, which, based on analyzing and processing a large amount of execution data to provide better parameter configuration recommendations, automatically determines hardware parameter configurations for job requests without requiring users to specify resource quantities for scheduling, thereby lowering the usage threshold of cluster software.

In order to achieve the above purpose, the disclosure proposes a runtime optimization method for a parallel computing application based on a remote intelligent service, including:
step S1, parsing, in a local cluster, an application job submitted by a user, acquiring application job features and local cluster features, and pushing the application job features and the local cluster features to a remote server;
step S2, receiving, by the remote server, a processing request for the application job features and the local cluster features submitted by the local cluster, and allocating, through a parameter search module of the remote server, a corresponding one of parameter search sub‑modules to perform parameter prediction for the application job, to thereby obtain a list of parameter configuration values;
step S3, delivering, by the remote server, the list of parameter configuration values to the local cluster, where the list of parameter configuration values includes one or more sets of parameter configuration values;
step S4, filtering out, by the local cluster through a custom method, a most suitable parameter configuration; feeding back, by the local cluster, specific values of the most suitable parameter configuration to the user; simultaneously modifying, by the local cluster, a number of hardware resources requested by the application job and parameter settings of the application job to obtain an optimized parameter configuration; and submitting, by the local cluster, the optimized parameter configuration to a local cluster scheduling system to complete actual execution of the application job;
step S5, monitoring, by the local cluster, the actual execution of the application job to obtain an actual execution status result, and uploading, by the local cluster, the actual execution status result to the remote server, where the actual execution status result includes a local actual execution time, a category to which the application job belongs, parameters related to parallel execution of the application job, and feature values of the application job and hardware operating environment parameters; and
step S6, expanding, by the remote server, a dataset in a historical job database; storing, by the remote server, received data of the actual execution status result into a dataset corresponding to an application category to obtain an updated dataset; and periodically updating, based on the updated dataset, the parameter search module.

In an embodiment, in step S1, the application job features are parameters affecting a computational cost of the application job, including an amount of computational data, a number of computational tasks, and an amount of communication; the local cluster features are feature representations obtained by processing environmental parameter configurations of the local cluster, and the environmental parameter configurations include hardware performance parameters of central processing units (CPUs), graphics processing units (GPUs), accelerators, and interconnection networks between nodes or between cards.

In an embodiment, in step S1, the application job submitted by the user includes job execution requirement parameters submitted by the user, and the job execution requirement parameters include three modes as follows: computation speed priority, hardware efficiency priority, and speed‑efficiency balance.

In an embodiment, in step S2, the parameter search module is divided into the parameter search sub‑modules of different types according to different application categories, and is configured with different Er values; and the parameter search sub‑modules are trained according to corresponding application job data in the historical job database, and Er represents a quality evaluation indicator.

In an embodiment, in step S3, the one set of parameter configuration values includes parallel parameters of subtasks in an application task, values of the parallel parameters, hardware resource parameters of the application job, and values of the hardware resource parameters.

In an embodiment, in step S4, the custom method includes: selecting, from the list of parameter configuration values returned by the remote server, hardware parameters most suitable for executing the application job on the local cluster, where the hardware parameters constitute a parameter configuration which maximizes idle resource utilization without exceeding a number of current idle resources of the local cluster.

The selecting, from the list of parameter configuration values returned by the remote server, hardware parameters most suitable for executing the application job on the local cluster comprises the following steps:
step S41, selecting, from the list of parameter configuration values, multiple sets of candidate parameter configuration values which conform to permissions of the user and current execution conditions of the local cluster; and
step S42, sorting, according to job execution requirement parameters submitted by the user, the multiple sets of candidate parameter configuration values in order of quality, and selecting an optimal set of parameters.

In an embodiment, in step S6, the expanding, by the remote server, a dataset in a historical job database includes: collecting one or more sets of job execution data of the local cluster, where the one or more sets of job execution data of the local cluster is obtained by applying the list of parameter configuration values delivered by the remote server.

The disclosure further provides a runtime optimization system for a parallel computing application based on a remote intelligent service, including a local cluster and a remote server.

The local cluster includes: a feature extraction module, a request access module, a resource configuration module, and a scheduling system module. The feature extraction module is configured to extract feature description parameters related to parallel computing tasks of an application job which is to be executed. The request access module is configured to send application job features and local cluster features to the remote server and receive a list of parameter configuration values delivered by the remote server. The resource configuration module is configured to perform, from the list of parameter configuration values, filtering and sorting of parameter configuration values according to priorities set by a user and the local cluster, to thereby obtain an optimal parameter configuration to be executed. The scheduling system module is configured to manage and schedule actual execution of the application job.

The remote server includes: a parameter search module and a historical job database. The parameter search module is configured to generate, according to the application job features and the local cluster features, parameter configuration recommendations for the application job. The historical job database is configured to store and expand job execution data, to provide training data for the parameter search module.

In an embodiment, the parameter search module includes multiple parameter search sub‑modules; and the parameter search sub‑modules are configured to respectively process parameter optimization problems for different categories of applications, and periodically update, based on an updated dataset, the parameter search module. It should be noted that, in some embodiments, each of the feature extraction module, the request access module, the resource configuration module, the scheduling system module, the parameter search module, and the parameter search sub‑module described above is embodied by software stored in at least one memory and executable by at least one processor.

In an embodiment, the runtime optimization system is configured to support multiple local clusters sharing a parameter optimization service of the remote server.

Therefore, the runtime optimization method and the runtime optimization system for the parallel computing application based on the remote intelligent service provided by the disclosure have the following beneficial effects.
(1) The runtime optimization method and system for the parallel computing application based on the remote intelligent service according to the disclosure combine a local feature extraction module and a remote historical job database to optimize parameters related to parallel efficiency. The local feature extraction module extracts features based on a specific job and the current cluster hardware configuration, and thereby collects accurate, personalized configuration information of the local cluster. The remote parameter search module includes multiple sub‑modules, which respectively process parameters of commonly used software, and the remote high‑performance server provides robust and easy‑to‑use parameter search models to predict suitable hardware parameters. The disclosure provides the user with the relatively comprehensive remote service and the parameter feature extraction module that allows setting corresponding preferences.
(2) The disclosure improves the utilization rate of the job execution result on a supercomputing platform and advocates for constructing and expanding truly usable job execution datasets for each subdivided category of application types. A complete job execution involves multiple stages, including hardware resource allocation, job scheduling by the scheduling system, and actual execution, during which queuing and other factors may further increase executing costs. On the cluster platform, a large number of jobs are frequently submitted and executed, but such execution data cannot be fully utilized. Moreover, the executing cost of each successful parameter configuration yields a low conversion rate of experience for subsequent runs. In contrast to the large amount of underestimated idle data, there is a lack of high-quality job execution datasets for specific applications in practice. By requesting access to the remote parameter search model, not only can the parameters of the parameter search model be continuously updated, but the corresponding dataset can also be steadily expanded. In the framework of the disclosure, the historical job database is established remotely to collect and provide executing data of various applications to model training and learning for corresponding applications. Achieving basic optimization data sharing is beneficial not only for saving the cost of parallel parameter optimization for respective distributed clusters but also for better collecting execution data.
(3) The system proposed in the disclosure can better realize the potential of the high-performance platform in providing user services. The Users submit job features from the local cluster to the remote server, and multiple clusters share the parameter optimization service of the remote server. The high-concurrency processing of parameter prediction requests by the high-performance platform can significantly improve the utilization rate of the remote server cluster.

The disclosure assists the user in completing necessary hardware resource quantity settings and parallel parameter-related value estimations for jobs on supercomputing center clusters. That is, the user is completely relieved from the need to interact with hardware-parallelism-related parameters on the cluster software, which greatly simplifies the job execution process and reduces the learning cost of using supercomputing software. Under existing parameter search experience and methods, user‑specified parameter values are not necessarily accurate or reliable. The remote parameter search module of the disclosure, based on a large amount of data, can mine job‑parallel‑related parameters, hardware resource allocation quantities, and hidden hardware characteristics of the cluster from execution data, thereby significantly saving user's time in parameter adjustment and various job execution costs. Furthermore, the remote parameter search module helps the user automatically achieve efficient core number settings within the budget, enabling the user to run jobs without hardware awareness, thus better advancing scientific research work based on the high‑performance service platform.

The technical solution of the disclosure is further described in detail below with reference to the accompanying drawings and embodiments.

### BRIEF DESCRIPTION OF DRAWINGS

FIG. 1 illustrates a flowchart diagram of a runtime optimization method for a parallel computing application based on a remote intelligent service according to the disclosure.

FIG. 2 illustrates a sequence diagram of the runtime optimization method for the parallel computing application based on the remote intelligent service according to an embodiment 1 of the disclosure.

FIG. 3 illustrates a state diagram of a runtime optimization system for the parallel computing application based on the remote intelligent service according to the disclosure.

FIG. 4 illustrates a connection diagram of clusters and a remote server according to the disclosure.

### DETAILED DESCRIPTION OF EMBODIMENTS

In order to make the technical solutions, advantages, and objectives of the disclosure clearer, the technical solutions of the embodiments of the disclosure will be described clearly and completely below. The described embodiments are part of, rather than all of, the embodiments of the disclosure. All other embodiments obtained by those skilled in the art based on the described embodiments of the disclosure without any creative effort shall fall within the protection scope of the disclosure.

Unless otherwise defined, technical terms or scientific terms used in the disclosure shall have the ordinary meanings as understood by those skilled in the art to which the disclosure belongs.

### Embodiment 1

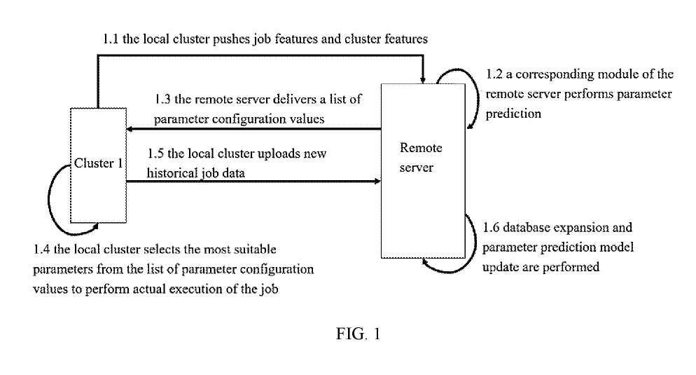

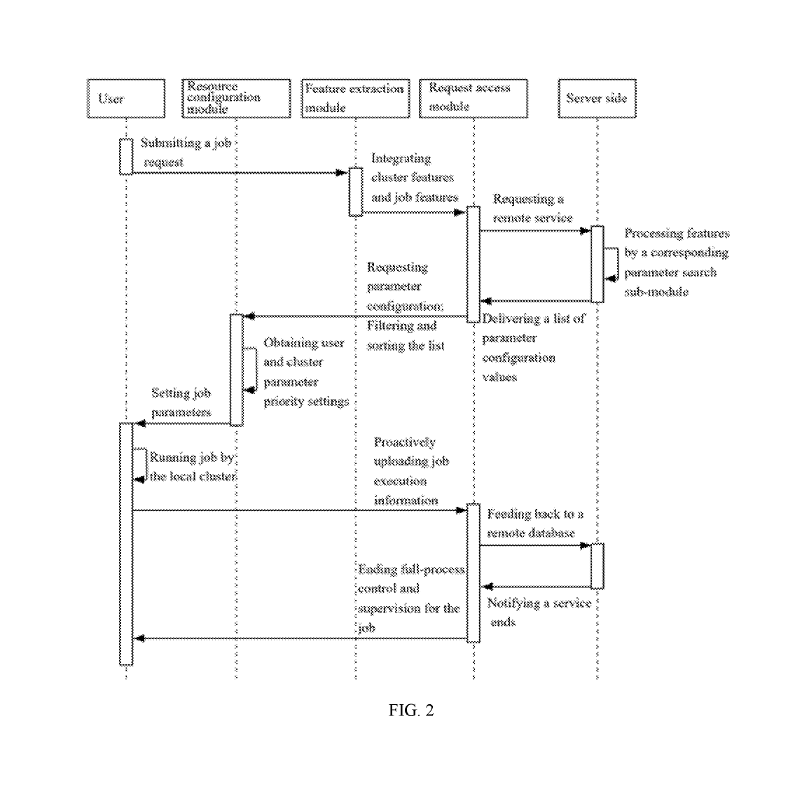

As shown in FIGS. 1-2, the disclosure proposes a runtime optimization method for a parallel computing application based on a remote intelligent service. The runtime optimization method includes the following steps SA1-SA6.
SA1, the local cluster acquires an application job submitted by a user.
SA2, the local cluster acquires an application category from information of the application job, and estimates feature input information of the application job to be executed according to the application category. The feature input information includes cluster features (i.e., local cluster features) and job features (i.e., application job features); The input corresponding to the cluster features is the local hardware environment at the current moment, and the input corresponding to the job features refers to input parameters and descriptions thereof in the application job that are unrelated to parallelization configurations such as the overall hardware resource quantity of the job and resource parameters of specific subtasks. Specifically, the job features are parameters that affect the computational cost such as the amount of computational data, the number of computational tasks, and the amount of communication. By examining the input parameters of the computational program and intermediate parameters obtained during pre-processing of the computational program, it is verified whether they affect the computational cost, and finally a list of feature parameters is obtained, along with their values.
SA3, the local cluster uploads the feature input information of the application job to be executed and requests the remote parameter optimization service, to obtain a list of parameter configuration values composed of multiple sets of parameter estimation information, each set of parameter estimation information includes assignments of the overall hardware resource quantity of the job and the resource parameters for specific subtasks.
SA4, the remote server forwards the list of parameter configuration values for the application job to be executed to the local cluster.
SA5, the local cluster receives the list of parameter configuration values, obtains an optimal parameter combination by a filtering and sorting method defined by the user and the local cluster, and modifies the configuration of the application job to be executed to obtain an optimized parameter configuration.
SA6, the local cluster performs actual execution of the application job according to the optimized parameter configuration, and feeds back execution data to a historical job database.

In step SA2, the local hardware environment refers to hardware configurations unique to the local hardware, such as the number of nodes, the number of cores, and their relationships. The overall hardware resource quantity of the job refers to the estimated hardware allocation value for the job to be executed, such as the total amount of CPU cores and GPUs requested when the job runs. The resource parameter configuration for specific subtasks refers to, for different application categories, the parallel-related parameter settings within the job, which need to be determined based on the overall hardware resource quantity of the job.

### Embodiment 2

As shown in FIG. 3, the disclosure further proposes a runtime optimization system for a parallel computing application based on a remote intelligent service. The runtime optimization system includes a local cluster and a remote server.

The local cluster includes: a feature extraction module, a request access module, a resource configuration module, and a scheduling system module. The feature extraction module is subdivided into sub-modules according to specific application categories, and is configured to extract feature representations of the job to be executed and of the local cluster hardware; the input to the feature extraction module has two parts: job parameter descriptions that are extracted as job features and are not directly related to job parallelization, and necessary local hardware environment configurations that are extracted as cluster features; and the output of this module is feature input information that can be utilized by the remote parameter search module. The resource configuration module is configured to perform, from the list of parameter configuration values, filtering and sorting of parameter configuration values according to priorities set by a user and the local cluster, to thereby obtain an optimal parameter configuration to be executed. The request access module is configured to send application job features and local cluster features to the remote server and receive a list of parameter configuration values delivered by the remote server. The scheduling system module is configured to manage and schedule actual execution of the application job;

The parameter feature extraction model may also be obtained by training using locally stored historical job data, which includes hardware operating environment, original job information and its processed features, and actual execution resource assignments of jobs. After a job finishes execution, the parameter feature module is configured to collect necessary job information including the actual runtime of the job, and optionally add the necessary job information to a local historical job database for timely training of the local feature module.

The remote server includes: a parameter search module and a historical job database. The parameter search module is configured to generate, according to the application job features and the local cluster features, parameter configuration recommendations for the application job to be executed; the ranking in the parameter list refers to Er values, which are quality evaluation indicators. The historical job database is configured to store and expand job execution data, to provide training data for the parameter search module.

The parameter search module includes multiple subdivided parameter search sub‑modules, each parameter search sub‑module is trained from job execution data of a corresponding application in the historical job database, and the parameter search sub‑modules are configured to respectively process parameter optimization problems for different categories of applications. Since the remote server‑side parameter search module may lack sufficient training due to insufficient data in the remote historical job database in the early stage, an empirical model of the relevant application field can be used to generate a list of several estimated parameter configurations for the application job to be executed. The local cluster then performs trial runs to obtain actual execution data for the corresponding configurations, thereby supplementing the data in the remote server‑side historical job database.

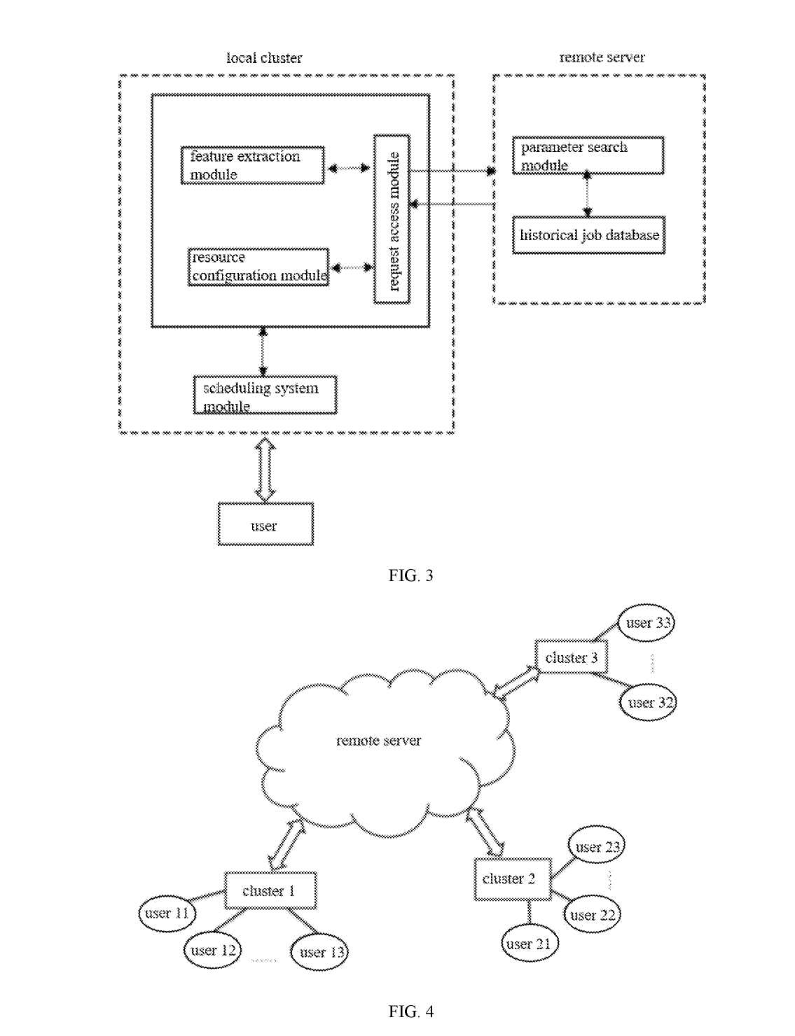

As shown in FIG. 4, the runtime optimization system and the runtime optimization method support multiple local clusters sharing a parameter optimization service of the remote server.

### Embodiment 3

In this embodiment, a commonly used job scheduling system on the supercomputing platform, the simple Linux utility for resource management (SLURM) job scheduling system, and a commonly used scientific computing software, VASP, are taken as examples to further explain the runtime optimization method and the runtime optimization system for the parallel computing application based on the remote intelligent service provided by the disclosure. The specific operation steps are as follows:
Step 1, a user submits a VASP application job to the SLURM job management system through a submission system. The submission system obtains and passes the job input information to a feature extraction module. The job input information includes an application category description, input file paths, hardware resource request information, a sequence of instructions in the job, etc.
Step 2, the feature extraction module receives the job input information and, based on the application category description therein, assigns the job to a corresponding feature extraction sub‑module. The feature extraction sub‑module estimates whether different inputs and parameters from the pre‑processing process affect the computational cost of the VASP job, to thereby obtain influential parameters such as the number of bands, the number of atoms, the number of reduced k‑points, the energy cutoff value, the number of images in transition state calculations, the size of the Fourier transform array, etc., as job features. At the same time, the feature extraction module collects various hardware parameters of the local cluster at the current moment and uses them as input to generate a corresponding local cluster feature representation. A request access module sends the feature input information, which includes the job features and cluster features, to the remote parameter search module.
Step 3, after receiving the feature input information, the remote parameter search module outputs a list of estimated parameter values including the overall job resource quantity (the overall hardware resource quantity of the job) and job-specific subtask parameters. The specific process includes the following steps: according to the application category description therein, the job is assigned to the corresponding parameter search sub‑module for parameter prediction. For the specific subtask of the VASP job, the parameters highly relevant to parallel execution efficiency are the number of bands treated in parallel (NPAR), the number of k-points computed in parallel (KPAR), and the number of cores (NCORE), and these three parameters follow the constraint that their product equals the total number of cores allocated to the job. The parameter prediction sub‑module for the VASP job based on the historical job database predicts multiple sets of job-specific subtask parameters for parallel‑related parameters and hardware resource configuration values for the overall job resource quantity.
Step 4, the local cluster receives the list of parameter configuration values returned by the remote parameter search module, and the resource configuration module performs two processes: filtering and sorting. The local cluster performs a basic filtering of the parameter configuration values in combination with the current idle resources of the cluster, performs a high‑level filtering of the parameter value configurations in combination with the user's permissions and preferences, to thereby obtain an optimal parameter combination, and modifies the configuration of the job to be executed accordingly to obtain an optimized parameter configuration.
Step 5, the local cluster performs actually execution of the application job according to the optimized parameter configuration, and feeds back the execution data to the remote historical job database.

In this embodiment, other parameters in the VASP job input file may affect the accuracy of the three main parallel-related parameters in step 2, such as the relationship between the number of k-points (NKPTS) and the KPAR. Training the feature extraction module can deeply mine the complex structure of job parameters, achieving higher efficiency and accuracy compared to empirical selection.

To complete the training of the parameter search sub‑module in step 3, it is necessary to prepare a high‑quality historical job execution dataset. When the remote historical job database is insufficiently built, the parameter search module adopts an empirical model to generate multiple parameter configuration recommendations, which are used by the local cluster to produce execution results of several test jobs. Important execution information from parameter searches, such as the actual job execution time on the remote cluster, various parameter assignments, hardware resource quantity settings, etc., is added to the remote database classified by application category, and is used to periodically update the corresponding parameter search sub‑module. Sufficient database data means that the amount of execution result feedback actually generated from various local clusters is enough to train the remote parameter search sub‑module until the error converges within a certain range; this part is set and adjusted manually. When the remote historical job database is sufficiently built, the parameter search module adopts one or more parameter search methods to generate a certain number of parameter configuration values, feeds the list back to the user via the access module, and collects the execution result. Based on the above, the parameter prediction task can be configured as parameter search, or as a combination of empirical model and parameter search, depending on different situations.

In specific implementation, the high-level filtering of the list of parameter configuration values in step 4 can be based on two methods: user permissions and user-specified job execution requirements. Filtering the parameter configuration values according to the user permissions means determining whether the maximum number of available hardware resources allocated to the user by the cluster matches the recommended hardware resource allocation in the current parameter configuration list. Filtering the most suitable parameter configuration according to the user-specified job execution requirement parameters refers to the parameter filtering preferences that the user must explicitly indicate before applying for job execution. This user-specified job execution requirement-based method automates the filtering process and combines it with user demands while omitting the actual user configuration process. The user-specified job execution requirement-based method includes, but are not limited to, computation speed priority, hardware efficiency priority, and speed-efficiency balance. The computation speed priority means that, under the same conditions, it tends to allocate abundant hardware resources to the job to be executed in order to accelerate the computation process of the application job; and the actual strategy is to select, from the available list of parameter configuration values, a set of search values with a relatively large number of computing cores. The hardware efficiency priority means that the cluster computing resources occupied to complete the task are minimized; and the actual strategy is to select, from the available list of parameter configuration values, a configuration with a relatively small number of computing cores. The speed-efficiency balance, as a compromise between the above two preceding filtering methods, selects a parameter configuration with a medium number of computing cores, achieving a balance between controlling the amount of allocated hardware resources and accelerating the computation.

For this embodiment, where the local cluster is configured with a specific job scheduling system, for example, the SLURM scheduling system allows setting a range of core numbers when submitting a job, the final selection of the most suitable hardware resource configuration value may comprehensively consider several sets of configuration values that rank relatively high.

For the case where a timeout occurs in receiving an acknowledgment message for the local cluster's request for remote parameter search service and feedback of the job execution information, the local request access control module automatically terminates the parallel computing application execution optimization process of the remote cloud service and promptly reports the exception to the user.

It should be noted that the contents not described in detail in the disclosure are all prior art and are well known to those skilled in the art.

Therefore, the disclosure provides the runtime optimization method and the runtime optimization system for the parallel computing application based on the remote intelligent service, which can optimize execution parameters of parallel computing applications, reduce data redundancy, improve the utilization rate of supercomputing platforms, lower user costs, and effectively advance scientific research work on high-performance service platforms.

Finally, it should be noted that the above embodiments are merely used to illustrate the technical solutions of the disclosure and not to limit the same. Although the disclosure has been described in detail with reference to the exemplary embodiments, those skilled in the art should understand that the technical solutions of the disclosure may still be modified or equivalently substituted, and such modifications or equivalent substitutions shall not cause the modified technical solutions to depart from the spirit and scope of the technical solutions of the disclosure.

What is claimed is:

1. A runtime optimization method for a parallel computing application based on a remote intelligent service, comprising the following steps:
step S1, parsing, in a local cluster, an application job submitted by a user, acquiring application job features and local cluster features, and pushing the application job features and the local cluster features to a remote server;
step S2, receiving, by the remote server, a processing request for the application job features and the local cluster features submitted by the local cluster, and allocating, through a parameter search module of the remote server, a corresponding one of parameter search sub‑modules to perform parameter prediction for the application job, to thereby obtain a list of parameter configuration values;
step S3, delivering, by the remote server, the list of parameter configuration values to the local cluster, wherein the list of parameter configuration values comprises one or more sets of parameter configuration values;
step S4, filtering out, by the local cluster through a custom method, a most suitable parameter configuration; feeding back, by the local cluster, specific values of the most suitable parameter configuration to the user; simultaneously modifying, by the local cluster, a number of hardware resources requested by the application job and parameter settings of the application job to obtain an optimized parameter configuration; and submitting, by the local cluster, the optimized parameter configuration to a local cluster scheduling system to complete actual execution of the application job;
step S5, monitoring, by the local cluster, the actual execution of the application job to obtain an actual execution status result, and uploading, by the local cluster, the actual execution status result to the remote server, wherein the actual execution status result comprises a local actual execution time, a category to which the application job belongs, parameters related to parallel execution of the application job, and feature values of the application job and hardware operating environment parameters; and
step S6, expanding, by the remote server, a dataset in a historical job database; storing, by the remote server, received data of the actual execution status result into a dataset corresponding to an application category to obtain an updated dataset; and periodically updating, based on the updated dataset, the parameter search module.

2. The runtime optimization method for the parallel computing application based on the remote intelligent service as claimed in claim 1, wherein in step S1, the application job features are parameters affecting a computational cost of the application job, comprising an amount of computational data, a number of computational tasks, and an amount of communication;
the local cluster features are feature representations obtained by processing environmental parameter configurations of the local cluster, and the environmental parameter configurations comprise hardware performance parameters of central processing units, graphics processing units, accelerators, and interconnection networks between nodes or between cards.

3. The runtime optimization method for the parallel computing application based on the remote intelligent service as claimed in claim 1, wherein in step S1, the application job submitted by the user comprises job execution requirement parameters submitted by the user, and the job execution requirement parameters comprise three modes as follows: computation speed priority, hardware efficiency priority, and speed‑efficiency balance.

4. The runtime optimization method for the parallel computing application based on the remote intelligent service as claimed in claim 1, wherein in step S2, the parameter search module is divided into the parameter search sub‑modules of different types according to different application categories and is configured with different Er values; and the parameter search sub‑modules are trained according to corresponding application job data in the historical job database, and Er represents a quality evaluation indicator.

5. The runtime optimization method for the parallel computing application based on the remote intelligent service as claimed in claim 1, wherein in step S3, the one set of parameter configuration values comprises parallel parameters of subtasks in an application task, values of the parallel parameters, hardware resource parameters of the application job, and values of the hardware resource parameters.

6. The runtime optimization method for the parallel computing application based on the remote intelligent service as claimed in claim 1, wherein in step S4, the custom method comprises: selecting, from the list of parameter configuration values returned by the remote server, hardware parameters most suitable for executing the application job on the local cluster, wherein the hardware parameters constitute a parameter configuration maximizing idle resource utilization without exceeding a number of current idle resources of the local cluster; and
wherein the selecting, from the list of parameter configuration values returned by the remote server, hardware parameters most suitable for executing the application job on the local cluster comprises the following steps:
step S41, selecting, from the list of parameter configuration values, multiple sets of candidate parameter configuration values conforming to permissions of the user and current execution conditions of the local cluster; and
step S42, sorting, according to job execution requirement parameters submitted by the user, the multiple sets of candidate parameter configuration values in order of quality, and selecting an optimal set of parameters.

7. The runtime optimization method for the parallel computing application based on the remote intelligent service as claimed in claim 1, wherein in step S6, the expanding, by the remote server, a dataset in a historical job database comprises: collecting one or more sets of job execution data of the local cluster, wherein the one or more sets of job execution data of the local cluster is obtained by applying the list of parameter configuration values delivered by the remote server.

8. A runtime optimization system for a parallel computing application based on a remote intelligent service, comprising: a local cluster and a remote server,
wherein the local cluster comprises: a feature extraction module, a request access module, a resource configuration module, and a scheduling system module; the feature extraction module is configured to extract feature description parameters related to parallel computing tasks of an application job which is to be executed; the request access module is configured to send application job features and local cluster features to the remote server and receive a list of parameter configuration values delivered by the remote server; the resource configuration module is configured to perform, from the list of parameter configuration values, filtering and sorting of parameter configuration values according to priorities set by a user and the local cluster, to thereby obtain an optimal parameter configuration to be executed; and the scheduling system module is configured to manage and schedule actual execution of the application job; and
wherein the remote server comprises: a parameter search module and a historical job database; the parameter search module is configured to generate, according to the application job features and the local cluster features, parameter configuration recommendations for the application job; and the historical job database is configured to store and expand job execution data, to provide training data for the parameter search module.

9. The runtime optimization system for the parallel computing application based on the remote intelligent service as claimed in claim 8, wherein the parameter search module comprises multiple parameter search sub‑modules; and the parameter search sub‑modules are configured to respectively process parameter optimization problems for different categories of applications, and periodically update, based on an updated dataset, the parameter search module.

10. The runtime optimization system for the parallel computing application based on the remote intelligent service as claimed in claim 8, wherein the runtime optimization system is configured to support multiple local clusters sharing a parameter optimization service of the remote server.
